(19) United States
(12) Patent Application Publication
(10) Pub. No.: US 2011/0218765 A1
(43) Pub. Date: Sep. 8, 2011

(54) Illustrating and Displaying Time and The Expiration Thereof

(76) Inventor: Janice L. Rogers, Cincinnati, OH (US)

(21) Appl. No.: 12/715,769

(22) Filed: Mar. 2, 2010

(51) Int. Cl. G04F 10/00

(52) U.S. Cl. 702/176; 368/107; 368/108

(57) ABSTRACT

Embodiments of the invention provide methods, apparatuses, and program products to manage time. In some embodiments, the method comprises receiving a countdown time that is associated with hours, minutes, and seconds, displaying a circular colored disc representing the hours, minutes, and seconds, and removing some of the disc in response to a portion of the countdown time elapsing. Alternative embodiments provide methods that comprise selecting a custom mode of an application that displays a circular colored disc, and inputting a predetermined time associated with hours, minutes, and seconds utilizing a time set area at the bottom of a window displayed in the custom mode, the disc being associated with the hours, minutes, and seconds. That method further comprises starting the custom mode to count down the predetermined time, wherein the disc represents the total of the predetermined time and, as time elapses, disappears.

### FIELD OF THE INVENTION

This invention relates generally to managing time, and more particularly to illustrating and displaying the expiration of time.

### BACKGROUND OF THE INVENTION

Managing time has become an increasingly important part of modern life. For example, it is often important to note not just the current time but also to note the remaining time in a specific predetermined amount of time. However, people often perceive the expiration of time as displayed by a digital countdown (e.g., through numbers increasing or decreasing) in a numeric sense. Unfortunately, people often focus on the changing numbers rather than the actual expiration of time. This can result in the appearance of time moving either more slowly or more quickly than it actually is. Thus, people often miss deadlines or fail to finish various tasks in a time allotted.

### SUMMARY OF THE INVENTION

Embodiments of the invention address the drawbacks of the prior art and make it easier for people to understand the concept of elapsed time. The present invention allows the user to see time as a measurement instead of positions on a clockface or a digital readout. Specifically, embodiments of the invention provide a method, apparatus, and program product to manage time. In some embodiments, the method comprises receiving, with a hardware processing element, a countdown time that is associated with hours, minutes, and seconds. The method further comprises graphically displaying a circular colored disc representing the minutes, hours, and seconds, and, in response to at least a portion of the countdown time elapsing, removing at least a portion of the disc.

In alternative embodiments, another method of managing time is provided. The method comprises selecting a custom mode of an application, wherein the custom mode displays a fully circular colored disc, and inputting a predetermined time associated with hours, minutes, and seconds utilizing a time set area at the bottom of a window displayed in the custom mode, wherein the disc represents the minutes, hours, and seconds inputted by the user. The method further comprises starting the custom mode to count down the predetermined time, wherein the disc represents the total of the predetermined time and, as time elapses, the disc disappears.

These and other objects and advantages will be more readily apparent from the following drawings and detailed description.

### BRIEF DESCRIPTION OF THE DRAWINGS

FIG. 1 is a diagrammatic illustration of a hardware and software environment that includes an apparatus consistent with embodiments of the invention;

FIG. 2 is an illustration of a countdown screen that may be displayed by the apparatus of FIG. 1 in which a user can configure and implement a countdown for a predetermined number of hours and minutes;

FIG. 3 is an illustration of a countdown screen that may be displayed by the apparatus of FIG. 1 in which a user can configure and implement a countdown for a predetermined number of minutes;

FIG. 4 is an illustration of a countdown screen that may be displayed by the apparatus of FIG. 1 in which a user can configure and implement a countdown for a predetermined number of seconds;

FIG. 5A is an illustration of the countdown screen of FIG. 2 that further illustrates a timer/clock located in a first location on the screen;

FIG. 5B is an illustration of the countdown screen of FIG. 2 that further illustrates a timer/clock located in a second location on the screen;

FIG. 6 is an illustration of the countdown screen of FIG. 2 after about twelve minutes and about one second have elapsed from a three-hour countdown to indicate the expiration of time as well as the removal of a portion of a colored area proportional to the ratio of the elapsed time to the total countdown time;

FIG. 7A is an illustration of a countdown screen that may be displayed by the apparatus of FIG. 1 in which a user can configure and implement a countdown for a predetermined number of hours, minutes, and seconds;

FIG. 7B is an illustration of the countdown screen of FIG. 7B after about ten seconds have elapsed from a one-minute countdown to indicate the expiration of time as well as the removal of a portion of a colored disc proportional to the ratio of the elapsed time to the total countdown time;

FIG. 8 is an illustration of a clock screen that may be displayed by the apparatus of FIG. 1 in which is displayed the current time;

FIG. 9 is an illustration of a setup screen that may be displayed by the apparatus of FIG. 1 in which a user can configure a current or future countdown;

FIG. 10A is an illustration of the clock screen of FIG. 8 after a countdown that is less than an hour but more than a minute has been configured;

FIG. 10B is an illustration of the clock screen of FIG. 8 after a countdown that is less than a minute has been configured;

FIG. 11 is an illustration of a fullscreen mode in which to view the countdown screen of FIG. 6;

FIG. 12 is an options screen that may be displayed by the apparatus of FIG. 1 in which the user may configure options to manage time;

FIG. 13 is a flowchart illustrating a sequence of operations executable by at least a portion of the apparatus of FIG. 1 to display a colored area and/or disc and remove portions thereof as time expires from a countdown;

FIG. 14 is a flowchart illustrating a sequence of operations executable by at least a portion of the apparatus of FIG. 1 to determine whether to repeat a countdown;

FIG. 15 is a flowchart illustrating a sequence of operations executable by at least a portion of the apparatus of FIG. 1 to determine whether to sound a pre-alarm and/or selectively blink an area or disc associated with a countdown; and

FIG. 16 is a flowchart illustrating a sequence of operations executable by at least a portion of the apparatus of FIG. 1 to pause and resume a countdown.

It should be understood that the appended drawings are not necessarily to scale, presenting a somewhat simplified representation of various features illustrative of the basic principles of embodiments of the invention. The specific design features of embodiments of the invention as disclosed herein, including, for example, specific dimensions, orientations, locations, and shapes of various illustrated components, as well as specific sequences of operations (e.g., including concurrent and/or sequential operations), will be determined in part by the particular intended application and use environment. Certain features of the illustrated embodiments may have been enlarged or distorted relative to others to facilitate visualization and clear understanding.

### DETAILED DESCRIPTION OF THE DRAWINGS

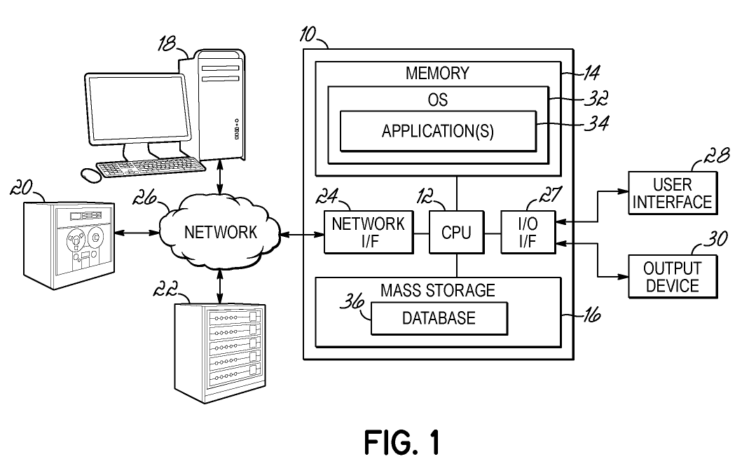

Referring to the drawings, and particularly to FIG. 1, there is illustrated a diagrammatic illustration of a hardware and software environment for an apparatus 10 configured to manage time (e.g., graphically display time and/or the expiration thereof) consistent with embodiments of the invention. Apparatus 10, in specific embodiments, is a computer, computer system, computing device, server, disk array, or programmable device such as a multi-user computer, a single-user computer, a handheld computing device, a networked device (including a computer in a cluster configuration), a telecommunications device, a video game console (or other gaming system), a wrist-watch, etc. Apparatus 10 may be referred to as “computing apparatus,” but will be referred to herein as “computing system.”

The computing system 10 includes at least one hardware processing element 12, such as at least one central processing unit (“CPU”) 12 coupled to a memory 14. Each CPU 12 is typically implemented in hardware using circuit logic disposed on one or more physical integrated circuit devices or chips. Each CPU 12 may be one or more microprocessors, micro-controllers, field programmable gate arrays, or ASICs, while memory 14 may include random access memory (RAM), dynamic random access memory (DRAM), static random access memory (SRAM), flash memory, and/or another digital storage medium, and also typically implemented using circuit logic disposed on one or more physical integrated circuit devices, or chips. As such, memory 14 may be considered to include memory storage physically located elsewhere in the computing system 10, e.g., any cache memory in the at least one CPU 12. Additionally, memory 14 may be considered to include any storage capacity used as a virtual memory, e.g., as stored on a mass storage device 16, another computing system 18, a network storage device 20 (e.g., a tape drive), or another network device 22 (hereinafter, a “server” 22) coupled to computing system 10 through at least one network interface 24 (illustrated as, and hereinafter, “network I/F” 24) by way of at least one network 26. It will be appreciated that the at least one network 26 may include at least one private communications network (e.g., such as an intranet) and/or at least one public communications network (e.g., such as the Internet). Similarly to the computing system 10, computing system 18 or server 22, in specific embodiments, is a computer, computer system, computing device, server, disk array, or programmable device such as a multi-user computer, a single-user computer, a handheld computing device, a networked device (including a computer in a cluster configuration), a telecommunications device, a video game console (or other gaming system) a wrist-watch, etc.

The computing system 10 may be coupled to at least one peripheral device through an input/output device interface 27 (illustrated as, and hereinafter, “I/O I/F” 27). In particular, the computing system 10 may receive data from a user through at least one user interface 28 (including, for example, a keyboard, mouse, a microphone, a dial, and/or other user interface) and/or output data to the user through at least one output device 30 (including, for example, a display, speakers, a printer, and/or another output device). Moreover, in some embodiments, the I/O I/F 27 communicates with a device that is operative as a user interface 28 and output device 30 in combination, such as a touch screen display (not shown).

The computing system 10 is typically under the control of an operating system 32 and executes or otherwise relies upon various computer software applications, sequences of operations, components, programs, files, objects, modules, etc., consistent with embodiments of the invention. In specific embodiments, the computing system 10 executes or otherwise relies on one or more applications 34 to manage time consistent with embodiments of the invention. In further specific embodiments, the application 34 may be a Time Timer® application as distributed by Time Timer, LLC, of Madeira, Ohio. Moreover, and in specific embodiments, the computing system 10 is configured with a database 36 to store data consistent with embodiments of the invention.

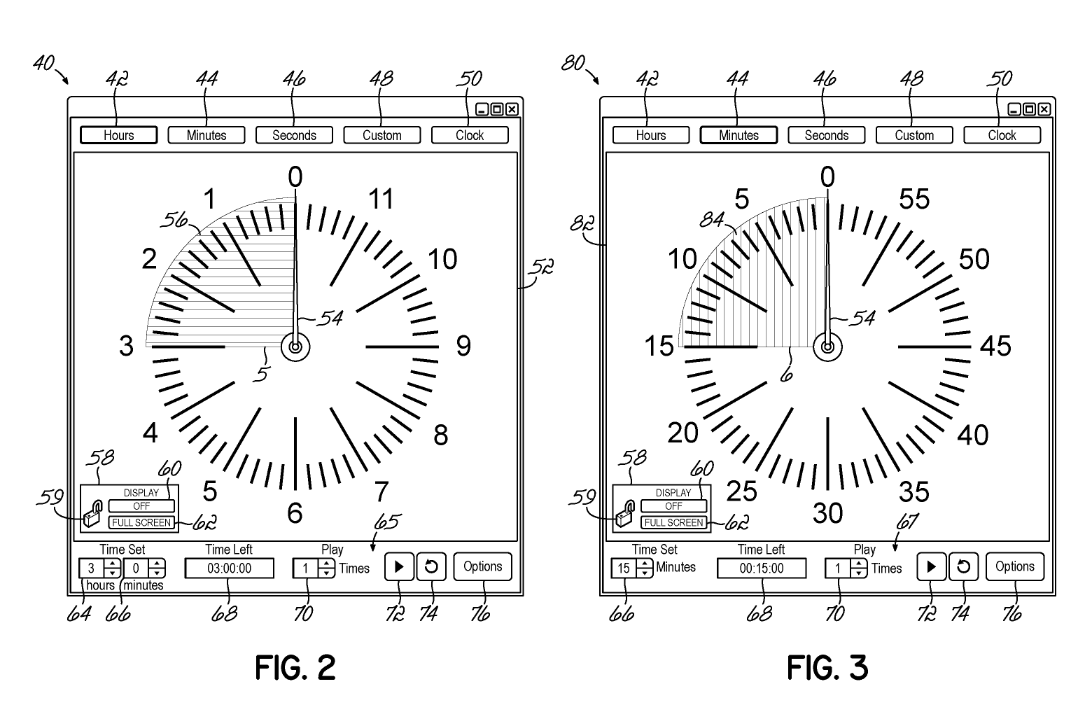

In some embodiments, the application 34 is configured to manage time through at least one graphical user interface. In particular, the graphical user interface may display various representations that help illustrate the current time, the current expiration of time, the future expiration of time, and/or options associated therewith, amongst other representations. For example, and consistent with embodiments of the invention, FIGS. 2-4, 5A-5B, 6, 7A-7B, 8-9, 10A-10B, and 11-12 illustrate a plurality of screens 40, 80, 90, 110, 120, 140, 170, and/or 180 that may be displayed by the application 34.

The application 34 has five modes: 1) an “Hours” countdown mode which may be activated by the user selecting button 42; 2) a “Minutes” countdown mode which may be activated by the user selecting button 44; a “Seconds” countdown mode which may be activated by the user selecting button 46; a “Custom” countdown mode which may be activated by the user selecting button 48; and a “Clock ” countdown mode which may be activated by the user selecting button 50.

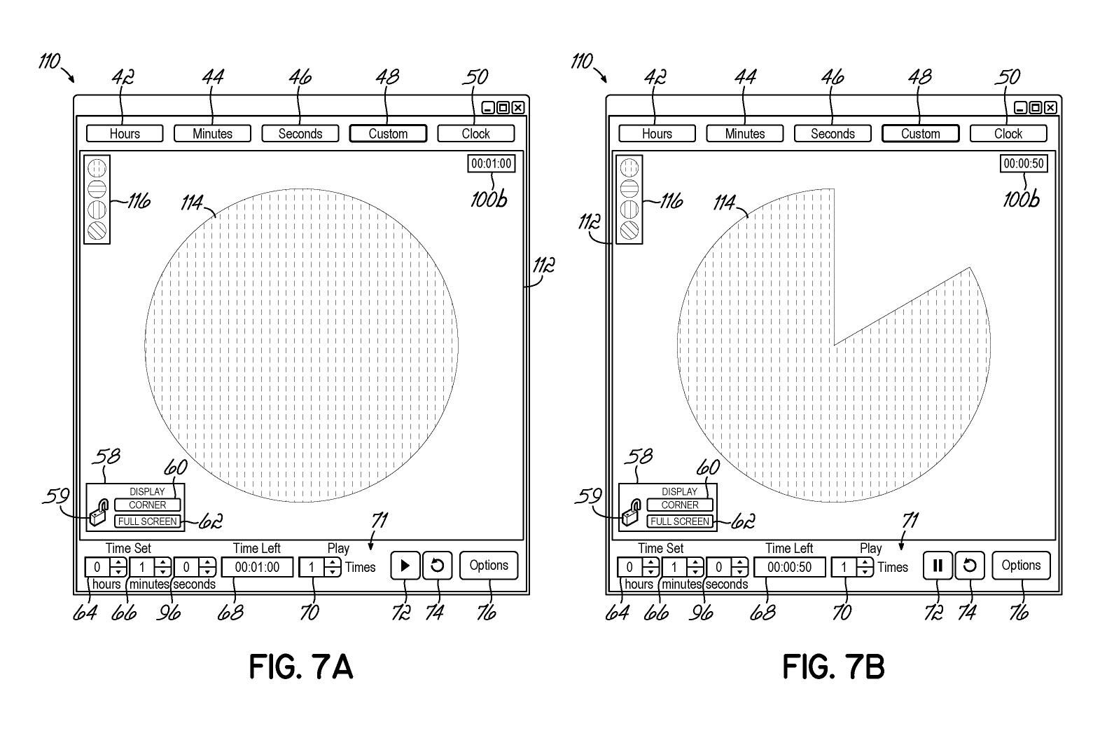

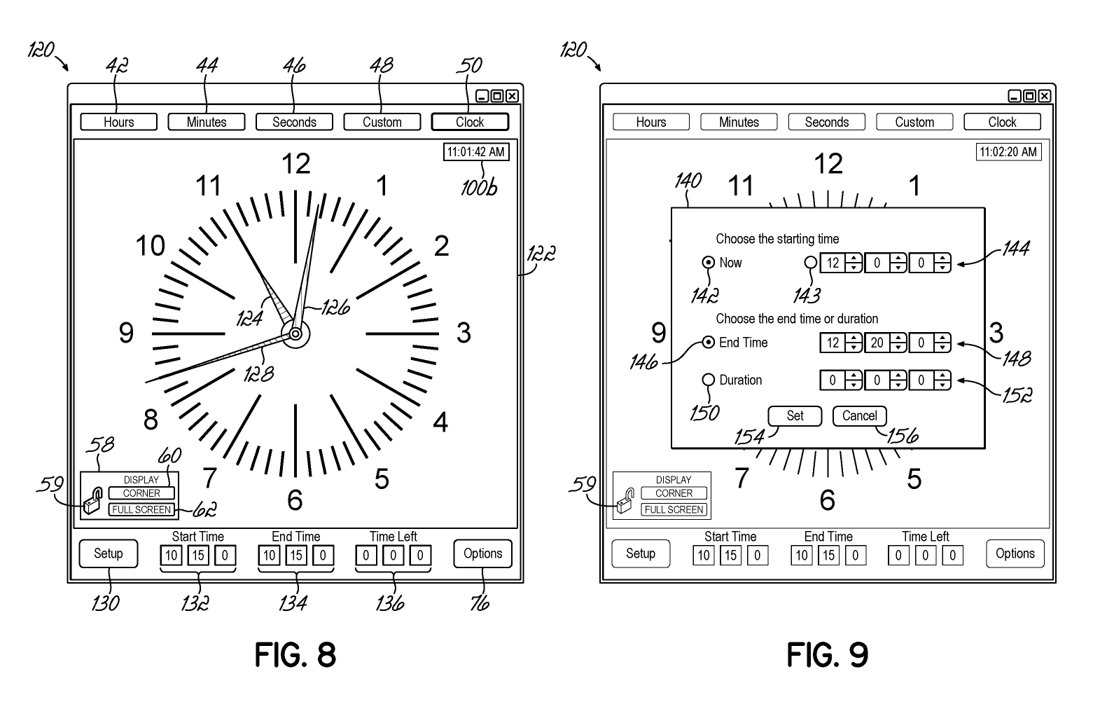

FIG. 2 is an illustration of a countdown screen 40 in which a user can configure and implement an hours countdown (e.g., an “hours” countdown screen 40) consistent with embodiments of the invention. In particular, the hours countdown screen 40 further illustrates various components common to many of the screens 40, 80, 90, 110, and/or 120. Specifically, the hours countdown screen 40 includes an “Hours” button 42 that the user may select to configure and implement an hours countdown (e.g., a countdown in which a user specifies a number of hours and minutes to count down), a “Minutes” button 44 that the user may select to configure and implement a minutes countdown (e.g., a countdown in which a user specifies a number of minutes to count down), a “Seconds” button 46 that the user may select to configure and implement a seconds countdown (e.g., a countdown in which a user specifies a number of seconds to count down), a “Custom” button 48 that the user may select to configure and implement a custom countdown (e.g., a countdown in which a user specifies a number of hours, minutes, and seconds to count down) and thus create a screen like screen 110, as shown in FIGS. 7A and 7B, and a “Clock” button 50 that the user may select to view a clock screen 120, as shown in FIGS. 8, 9, 10A and 10B.

The hours countdown screen 40 further includes one embodiment of a countdown face 52 that includes a plurality of indicia marks (sixty line segments and numerals) arranged circularly around the center of the countdown face 52. For example, and in one embodiment, the countdown face 52 is similar to a clock face and includes numbers each fifth indicia mark that decrease by one, in a clock-wise manner, from eleven to zero (e.g., thus indicating the hours for a countdown). The countdown face 52 further includes a countdown indicator 54 that advances clockwise every second from one indicia mark to the next when a countdown has been started and time elapses. The hours countdown screen 40 also includes an adjustable colored area 56 on the countdown face 52 that graphically indicates the time remaining in a countdown. In specific embodiments, the adjustable colored area 56 is at least somewhat translucent with respect to the indicia marks and is colored blue. However, any color may be used.

In some embodiments, the countdown face 52 includes a display frame 58 that indicates whether the application 34 is locked (e.g., when the application 34 is locked it does not accept most user interactions therewith) as well as the current settings of a timer/clock (not shown in FIG. 2), and includes a button for a user to enter a fullscreen mode. As such, the display frame 58 includes a lock icon 59 (indicating whether the application 34 is locked), a timer/clock button 60 to display and configure the location of the timer/clock, as well as a fullscreen button 62 to allow the user to view a fullscreen mode of the countdown face 52.

To set the time for a countdown, the hours countdown screen 40 includes a time set area 65 at the bottom of the screen 40 including an hours selector 64 in which the user may enter hours for a countdown by typing the hours or interacting with buttons to adjust the hours up or down. The countdown screen 40 further includes a minutes selector 66 in which the user may enter minutes for a countdown by typing the minutes or interacting with buttons to adjust the minutes up or down. Additionally, the hours countdown screen 40 includes a time left indicator 68 which indicates the time remaining in a countdown with granularity to the second, as well as a repeat play selector 70 in which the user enters the number of times to repeat a countdown by typing that number of times or interacting with buttons to adjust the number of times up or down.

The hours countdown screen 40 includes a “Play” button 72 (illustrated with a play icon) that the user may select to start a countdown, as well as a reset button 74 that the user may select to restart a countdown. After the user has selected the “Play” button 72, the icon for that button may be changed to a pause icon until the “Play” button 72 is selected again. See FIG. 6. The hours countdown screen 40 further includes an “Options” button 76 that the user may select to view an options screen 180 shown in FIG. 12.

As an example and as illustrated in FIG. 2, the time left for a countdown is three hours. This may be set by the user one of two ways: 1) by adjusting the size of the area 56 (e.g., by increasing or decreasing the size of the area 56 by changing the position of an edge 5 of the area 56 on the countdown face 52) or by the user adjusting the countdown time (e.g., by setting the hours in the hours selector 64 and/or the minutes in the minutes selector 66).

FIG. 3 is an illustration of a countdown screen 80 in which a user can configure and implement a minutes countdown (e.g., a “minutes” countdown screen 80). Similarly to the hours countdown screen 40 of FIG. 2, the minutes countdown screen 80 of FIG. 3 includes the aforementioned “Hours” button 42, “Minutes” button 44, “Seconds” button 46, “Custom” button 48, “Clock” button 50, display frame 58, lock icon 59, timer/clock button 60, fullscreen button 62. The minutes countdown screen 80 of FIG. 3 further includes a time set area 67 at the bottom of the screen 80 including minutes selector 66, time left indicator 68, repeat play selector 70, “Play” button 72, reset button 74, and “Options” button 76. However, the minutes countdown screen 80 further includes an alternative embodiment of a countdown face 82. In particular, the countdown face 82 includes a plurality of indicia marks (e.g., as illustrated in FIG. 3, sixty) arranged circularly around the center of the countdown face 82. Thus, and again, the countdown face 82 is similar to a clock face. However, the countdown face 82 includes numbers each fifth indicia mark that decrease by five, in a clock-wise manner, from fifty-five to zero (e.g., thus indicating the minutes for a countdown). The countdown face 82 also includes the countdown indicator 54 that advances clockwise every second from one indicia mark to the next when a countdown has been started. Furthermore, the minutes countdown screen 80 includes an adjustable colored area 84 on the countdown face 82 that graphically indicates the time remaining in a countdown. In specific embodiments, the adjustable colored area 84 is at least somewhat translucent with respect to the indicia marks and is colored red. However, any color may be shown.

As an example and as illustrated in FIG. 3, the time left for a countdown is fifteen minutes. This may be set by the user adjusting the size of the area 84 by increasing or decreasing the size of the area 84 one of two ways: 1) by changing the position of an edge 6 of the area 84 on the countdown face 82 or 2) by the user adjusting the countdown time (e.g., by setting the minutes in the minutes selector 66 either using the arrows or typing in the desired number).

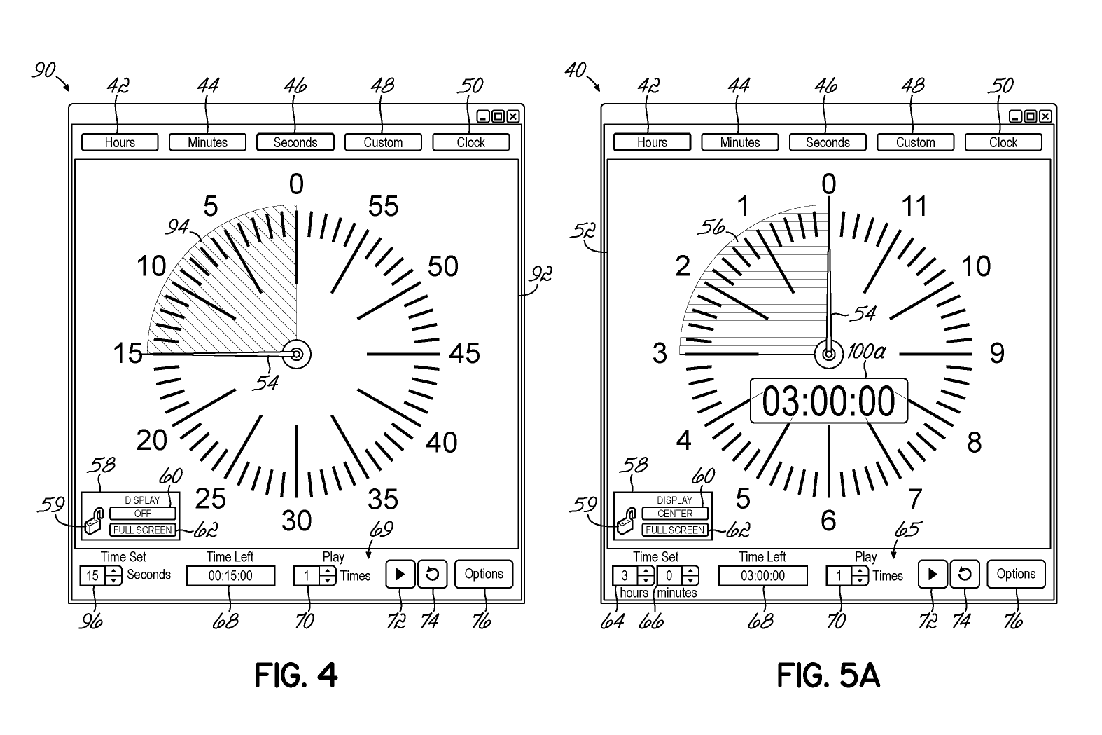

FIG. 4 is an illustration of a countdown screen 90 in which a user can configure and implement a seconds countdown (e.g., a “seconds” countdown screen 90). Similarly to the hours countdown screen 40 of FIG. 2, the seconds countdown screen 90 of FIG. 4 includes the aforementioned “Hours” button 42, “Minutes” button 44, “Seconds” button 46, “Custom” button 48, “Clock” button 50, display frame 58, lock icon 59, timer/clock button 60, fullscreen button 62. The seconds countdown screen 90 of FIG. 4 further includes a time set area 69 at the bottom of the screen 90 including a seconds selector 96, time left indicator 68, repeat play selector 70, “Play” button 72, reset button 74, and “Options” button 76. Moreover, and similarly to the minutes countdown screen 80 of FIG. 3, the seconds countdown screen 90 includes a countdown face 92 with plurality of indicia marks (e.g., as illustrated in FIG. 4, sixty) arranged circularly around the center of the countdown face 92 that further includes numbers each fifth indicia mark that decrease by five, in a clock-wise manner, from fifty-five to zero (e.g., thus indicating the seconds for a countdown). The countdown face 92 also includes the countdown indicator 54 that advances clockwise every second from one indicia mark to the next when a countdown has been started. Furthermore, the countdown screen 90 includes an adjustable colored area 94 on the countdown face 92 that graphically indicates the time remaining in a countdown. In specific embodiments, the adjustable colored area 94 is at least somewhat translucent with respect to the indicia marks and is colored green. However, any color may be used. Notably, the countdown indicator 54 is located at the opposite edge of the area 94 than it is in relation to areas 56 and 84 in FIGS. 2 and 3, respectively.

To set the time for a countdown, the seconds countdown screen 90 includes a seconds selector 96 in which the user may enter seconds for a countdown by selecting and then typing in the seconds or interacting with buttons to adjust the seconds up or down.

As an example and as illustrated in FIG. 4, the time left for a countdown is fifteen seconds. This may be set by the user adjusting the size of the area 94 one of two ways: 1) by increasing or decreasing the size of the area 94 by changing the position of an edge of the area 94 on the countdown face 92 or 2) by the user adjusting the countdown time (e.g., by setting the seconds in the seconds selector 96 either via the arrows or typing in a numeral in the seconds selector 96).

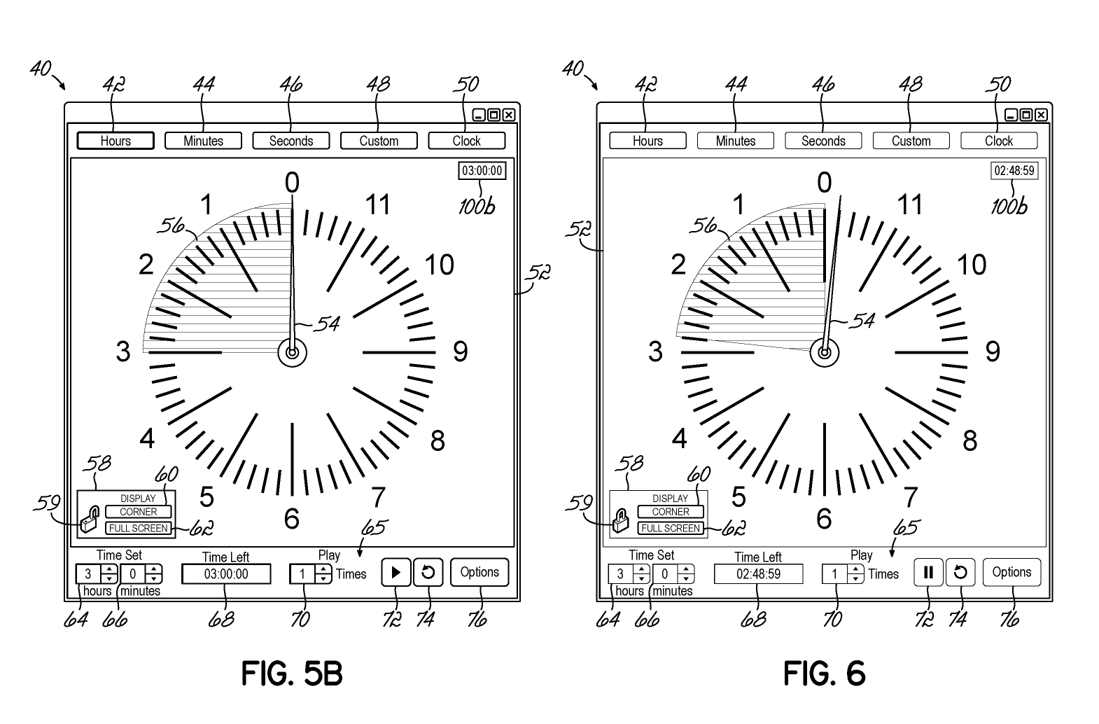

In some embodiments, a numeric timer/clock may be displayed, in addition to a graphic illustration, to further illustrate a countdown. The numeric display is controlled by a user selecting the timer/clock button 60. This button 660 changes the numeric display between “OFF”, “CENTER” and “CORNER.” For example, FIG. 5A is an illustration of the hours countdown screen 40, as shown in FIG. 2, that further illustrates a numeric timer/clock 100a located in a substantially central location of the countdown face 52 consistent with embodiments of the invention. Specifically, the numeric timer/clock 100a is displayed on the hours countdown screen 40 in response to the user selecting the timer/clock button 60 when that timer/clock button 60 indicates that the timer/clock is “OFF.”

Also for example, FIG. 5B is an illustration of the hours countdown screen 40 that further illustrates a timer/clock 100b located in a corner of the countdown face 52 consistent with alternative embodiments of the invention. Specifically, the timer/clock 100b is displayed on the hours countdown screen 40 in response to the user selecting the timer/clock button 60 when that timer/clock button 60 indicates that the timer/clock is in the “CENTER.” In response to a user selecting the timer/clock button 60 when that timer/clock button 60 indicates that the timer/clock is in the “CORNER,” the numeric timer/clock is disabled.

Portions of the areas 56, 84, and/or 94 of the respective hours countdown screen 40, minutes countdown screen 80, and/or seconds countdown screen 90 are removed as time expires in their respective countdowns. For example, and with specific reference to areas 56, 84, and 94 illustrated in FIGS. 2-4 and 5A-5B, the area 56 decreases by about a third every hour, the area 84 decreases by about a third every five minutes, and the area 94 decreases by about a third every five seconds. As a further example, FIG. 6 illustrates the hours countdown screen 40 after about twelve minutes and about one second has elapsed from a three-hour countdown. As illustrated, about one-fifteenth, or 6.67%, of the area 56 has been removed. In this manner, the hours countdown screen 40 (and, in a corresponding manner, the minutes countdown screen 80 and seconds countdown screen 90) illustrates the expiration of time in both a spatial sense (e.g., through the movement of the countdown indicator 54) as well as an at least partially absolute sense (e.g., through the decreasing size of the area 56).

In addition to the hours, minutes, and seconds countdowns or modes, a custom countdown or mode can be configured and implemented consistent with embodiments of the invention. In the custom countdown, the user selects a time to elapse by setting the hours, minutes, and/or seconds associated with the countdown (any of which can be equal to zero). The user inputs the desired time to elapse by setting selectors 64, 66 and 96 by entering the time or using the arrows associated with the selectors. The application 34 displays a full colored disc and decreases the area of that disc proportionately with respect to the ratio of the elapsed time to the total countdown or set time. For example, if the user inputs or configures a custom countdown time of five seconds, about one-fifth of the disc is removed about every second. However, if the user inputs or configures a custom countdown of five minutes, then about one-three-hundredth of the disc is removed about every second. In this manner, the expiration of time is continuously graphically illustrated in a fully absolute sense, as opposed to a spatial sense or partially absolute sense.

For example, FIG. 7A is an illustration of a countdown screen 110 in which a user can configure and implement a custom countdown (e.g., a “custom” countdown screen 110) consistent with embodiments of the invention. Specifically, the custom countdown screen 110 includes the aforementioned “Hours” button 42, “Minutes” button 44, “Seconds” button 46, “Custom” button 48, “Clock” button 50, display frame 58, lock icon 59, timer/clock button 60, fullscreen button 62. The custom countdown screen 110 of FIGS. 7A and 7B further includes a time set area 71 at the bottom of the screen 110 including hours selector 64, minutes selector 66, time left indicator 68, repeat play selector 70, “Play” button 72, reset button 74, “Options” button 76, seconds selector 96, and timer/clock 100b. Moreover, the custom countdown screen 110 includes another embodiment of a countdown face 112 that does not include a plurality of indicia marks arranged circularly around its center. Rather, the countdown face 112 includes a colored disc 114 that graphically indicates the time remaining in a countdown. Moreover, the custom countdown face 112 includes a color selector 116 for a user to select a color for the disc 114. As illustrated in FIG. 7A, the disc 114 is colored orange.

The disc 114 is initially full and portions of the disc 114 are removed as time expires. Thus, the disc 114 is illustrated in FIG. 7A as whole or fully colored prior to the user beginning the countdown. Once the countdown has begun, however, portions of the disc 114 are removed proportionately with respect to the ratio of elapsed time to the total countdown time. For example, FIG. 7B is an illustration of the custom countdown screen 110 after about ten seconds have elapsed from a one-minute countdown. As such, the disc 114 has decreased by about one-sixth, or 16.67%. In this manner, the custom countdown screen 110 illustrates the expiration of time in an absolute sense (e.g., through the decreasing size of the disc 114).

In some embodiments, a user can view the current time as well as set a current or future countdown consistent with embodiments of the invention. FIG. 8 is an illustration of a clock screen 120 in which a user may view the current time as well as set a current or future countdown. Specifically, the clock screen 120 includes the aforementioned “Hours” button 42, “Minutes” button 44, “Seconds” button 46, “Custom” button 48, “Clock” button 50, display frame 58, lock icon 59, timer/clock button 60, fullscreen button 62, “Options” button 76, and timer/clock 100b. Moreover, the clock screen 120 includes a clock face 122 with plurality of indicia marks (e.g., as illustrated in FIG. 8, sixty) arranged circularly around the center of the clock face 122 that further includes numbers each fifth indicia mark that increase by 1, in a clock-wise manner, from one to twelve.

The clock face 122 further includes an hours indicator 124 (to indicate the current hour), a minutes indicator 126 (to indicate the current minute), and a seconds indicator 128 (to indicate the current second). Thus, the clock face 122 generally corresponds to the look of a typical clock face. In specific embodiments, at least a portion of the hours indicator 124 is colored blue, at least a portion of the minutes indicator 126 is colored red, and at least a portion of the seconds indicator 128 is colored green.

In some embodiments, the clock screen 120 can be utilized to configure and implement a current or future countdown. As such, the clock screen 120 includes a “Setup” button 130 for the user to set up such a countdown, a “Start Time” indicator 132 for the user to view the start time for a countdown, an “End Time” indicator 134 for the user to view the end time for a countdown, and a “Time Left” indicator 136 for the user to view the time left for a countdown.

For example, FIG. 9 is an illustration of a setup screen 140 in which a user may configure a current or future countdown. The setup screen 140 includes an option to immediately start a countdown by selecting the “Now” option 142 or select a future time at which to start the countdown by selecting the user set time option 143. After selecting the user set time option 143, the user can specify the hour, minute, and second to start a countdown in an hour, minute, and second selector (collectively illustrated at 144) associated with that user set time option 143.

In the setup screen 140 the user also sets the end time for a countdown or sets the duration for a countdown. Specifically, the users sets an end time for a countdown by selecting an “End Time” option 146 and specifies the hour, minute, and second to end the countdown in an hour, minute, and second selector (collectively illustrated at 148) associated with that “End Time” option 146. Alternatively, the user sets a duration for the countdown by selecting a “Duration” option 150 and specifies the hours, minutes, and seconds for that duration in an hour, minute, and second selector (collectively illustrated at 152) associated with that “Duration” option 150. The user sets and automatically starts the countdown by selecting the “Set” button 154 or cancels the countdown by selecting the “Cancel” button 156.

In response to a user setting a countdown at the setup screen 140, the clock screen 120 may display one or more colored areas that graphically illustrate the length of a countdown. For example, if the time remaining in a countdown is less than a minute, only a green colored area for the remaining seconds is displayed. However, if the time remaining in a countdown is more than a minute but less than an hour, a red colored area for the remaining minutes and a blue colored area for the remaining fractions of an hour is displayed. Finally, if the time remaining in a countdown is more than an hour, only a blue colored area for the remaining hours (including fractions of an hour) is displayed. Thus, as time for a countdown elapses, the clock screen 120 may display any of the blue, red, or green colored areas based on the remaining time in a countdown.

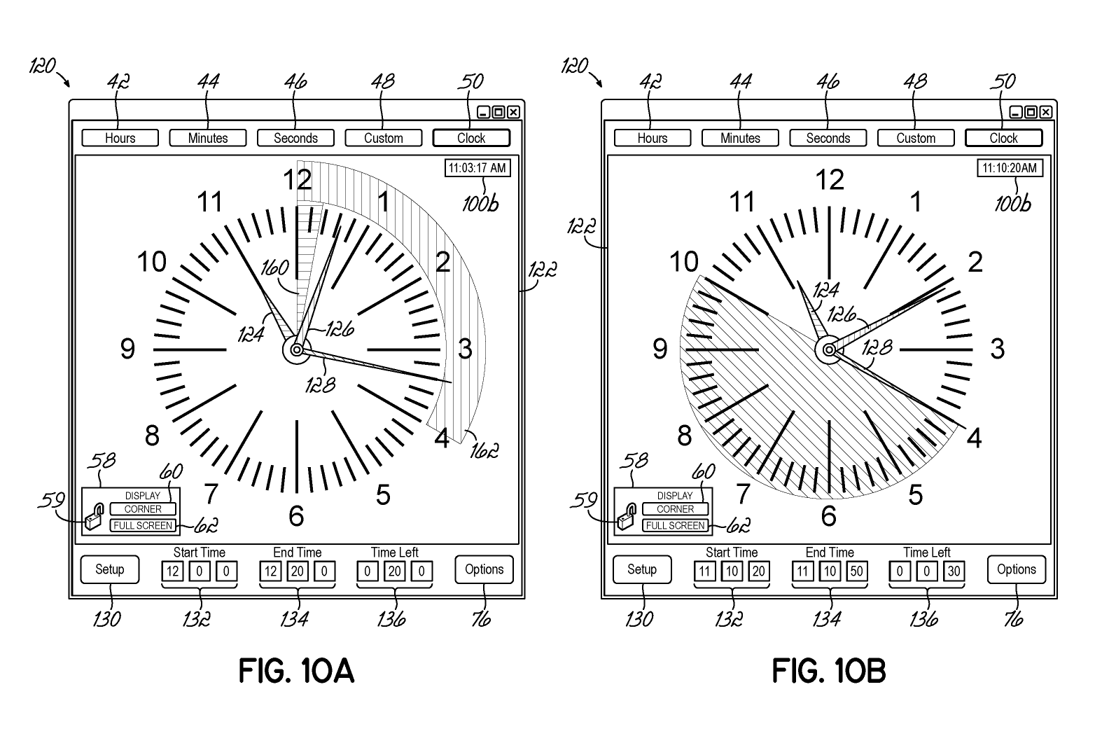

For example, FIG. 10A illustrates the clock screen 120 after a countdown that is less than an hour but more than a minute has been set. As such, the clock face 122 includes a first colored area 160 that is associated with the number of hours remaining in the countdown (e.g., as illustrated, one-third) and a second colored area 162 that is associated with the number of minutes that are remaining in the countdown (e.g., as illustrated, twenty). Specifically, FIG. 10A illustrates that the first colored area 160 is located on and within the indicia marks of the clock face 122, while the second colored area 162 is configured as a band around the indicia marks of the clock face 122 but that overlaps the numbers associated with those indicia marks. The colored areas 160 and 162 are not configured to overlap. In specific embodiments, the first colored area 160 is at least somewhat translucent with respect to the indicia marks and is colored blue, while the second colored area 162 is at least somewhat translucent with respect to the numbers associated with the indicia marks and is colored red.

Also for example, FIG. 10B illustrates the clock screen 120 after a countdown that is less than a minute has been set. As such, the clock face 122 includes a third colored area 164 that is associated with the number of seconds that are remaining in the countdown (e.g., as illustrated, thirty). Specifically, FIG. 10A illustrates that the third colored area 164 is located on and within the indicia marks of the clock face 122 similarly to the location of the first colored area 160. In specific embodiments, the third colored area 164 is at least somewhat translucent with respect to the indicia marks and is colored green.

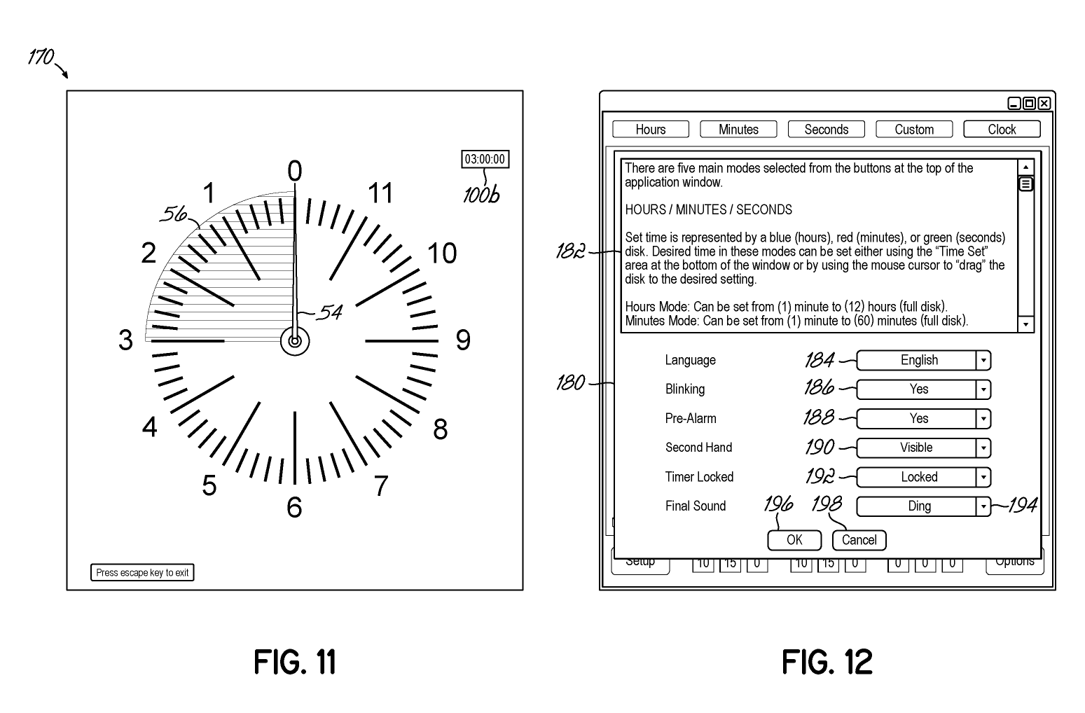

In some embodiments, any of the faces 40, 80, 90, 110, and/or 120 may be displayed in a fullscreen mode consistent with embodiments of the invention. For example, FIG. 11 is an illustration of a fullscreen view 170 of the hours countdown screen 40 illustrated in FIG. 6. In particular, the fullscreen view 170 illustrates the countdown face 52 of the hours countdown screen 40, and in particular the indicia marks, the countdown indicator 54, the area 56, and a timer/clock 100b associated therewith. The fullscreen view 170 is displayed in response to a user selecting the fullscreen button 62. The user may exit the fullscreen view 170 by interacting with the fullscreen view 170 and/or user interface 28, such as by pressing an “Escape” key.

The application 34 is associated with various options that can be set by the user. In response to selecting the “Options” button 76 on any of the screens 40, 80, 90, 110, and/or 120, the user can view an options screen 180 as illustrated in FIG. 12. The options screen 180 provides both a brief guide 182 on how to use the application 34 as well as options to adjust the language of text in the application 34 with a language drop-down menu 184. The options screen 180 also provides an option for the user to configure any of the areas 56, 84, 94, 164 and/or the disc 114 to blink when there is ten seconds or less time remaining in a countdown with a blinking drop-down menu 186. Similarly, the options screen 180 provides an option for the user to configure an alarm to sound when there is ten seconds remaining in a countdown with a pre-alarm drop-down menu 188. The options menu 180 also allows the user to set whether a seconds hand, or countdown indicator 54, is present during an hours, minutes, or seconds countdown with a second hand drop-down menu 190. Moreover, the user can lock the application 34 (e.g., prevent user input from being accepted by the application 34) with a lock drop-down menu 192 and allow the user to set the sound for a final alarm when a countdown has completely expired with a final sound drop-down menu 194. Alternatively, the user can lock or unlock the application 34 by selecting the lock icon 59 illustrated in FIGS. 2-4, 5A-5B, 6, 7A-7B, 8, 10A-10B, and 11, or by interacting with the user interface 28 to select a certain input, such as “CTRL+U” or “COMMAND+U.” When the application 34 is unlocked, the lock icon 59 is displayed as an unlocked lock (for example, see the lock icon 59 in FIGS. 2-4, 5A-5B, 7A-7B, 8-9, and 10A-10B). When the application is locked, however, the lock icon 58 is displayed as a locked lock (for example, see the lock icon 59 in FIG. 6). Returning to FIG. 12, the user saves the options by selecting the “OK” button 196 or cancels the options by selecting the “Cancel” button 198.

In some embodiments, the areas 56, 84, 94, 160, 162, 164 and/or the disc 114 are configured to be reduced proportionately with respect to the ratio of elapsed time to the total countdown time. Thus, for example, the areas 56 and 160 associated with hours decrease at a slower rate than the areas 84 and 162 associated with minutes. Similarly, the areas 84 and 162 decrease at a slower rate than the areas 94 and 164 associated with seconds. Similarly, the larger the time for a custom countdown, the slower the decrease in the area of the disc 114.

A person having ordinary skill in the art will recognize that the environments illustrated in FIGS. 1-4, 5A-5B, 6, 7A-7B, 8-9, 10A-10B, and 11-12 are not intended to limit the scope of embodiments of the invention. In particular, computing system 10, computing system 18, and/or server 22 may include fewer or additional components consistent with alternative embodiments of the invention. Indeed, a person having skill in the art will recognize that other alternative hardware and/or software environments may be used without departing from the scope of the invention. For example, the application 34 may be configured with one or more modules configured to implement particular portions of embodiments of the invention, while the database 36 may be configured with one or more data structures configured to store data associated with the application 34. Additionally, a person having ordinary skill in the art will appreciate that the computing system 10 may include more or fewer applications disposed therein. As such, other alternative hardware and software environments may be used without departing from the scope of embodiments of the invention.

For example, one having ordinary skill in the art will appreciate that the timer/clock 100 can be provided on any of screens 40, 80, 90, 110, 120, and/or 170 consistent with embodiments of the invention. As such, the timer/clock 100 may display the time remaining in a countdown on screens 40, 80, 90, 110, and/or 170, or display the current time in screens 120 and/or 170. Similarly, one having ordinary skill in the art will appreciate that the timer/clock 100 may be located in different areas of the screens 40, 80, 90, 110, and/or 170 consistent with embodiments of the invention.

Moreover, one having ordinary skill in the art will appreciate that the application 34 may incorporate different user interface components than those described and illustrated. For example, the application 34 may utilize different user interfaces than buttons, text entry boxes, selectors, selection options, drop-down menus, and selectable icons consistent with embodiments of the invention. Also for example, the application 34 may use more or fewer user interfaces consistent with embodiments of the invention.

Furthermore, one having ordinary skill in the art will appreciate that embodiments of the invention may utilize alternative rotational directions to indicate the expiration of time than those illustrated. Specifically, various embodiments of the invention illustrate that time expires and portions of colored areas or discs are removed in a clockwise direction. However, alternative embodiments of the invention may illustrate that time expires and portions of colored areas or discs are removed in a counter-clockwise direction. For example, and with respect to FIGS. 7A-7B, alternative embodiments of the invention may display the disc 114 and remove portions of the disc in a counter-clockwise direction as time expires. Moreover, alternative embodiments of the invention may include more or fewer indicia marks as well as more or fewer numbers associated with the indicia marks. Still furthermore, more or fewer colors for the various colored areas and discs, and alternative colors for the various colored areas and discs, may be used. These different colors can include white (e.g., when a background for the area or disc is not white) as well as black and gray.

The routines executed to implement the embodiments of the invention, whether implemented as part of an operating system or a specific application, component, program, object, module or sequence of instructions executed by one or more hardware processing elements will be referred to herein as a “sequence of operations,” a “program product,” or, more simply, “program code.” The program code typically comprises one or more instructions that are resident at various times in various memory and storage devices, and that, when read and executed by one or more hardware processing elements, cause that hardware processing element, or the apparatus configured thereupon, to perform the steps necessary to execute steps, elements, and/or blocks embodying the various aspects of the invention.

While the invention has and hereinafter will be described in the context of fully functioning apparatuses, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to physical and tangible recordable type media such as volatile and nonvolatile memory devices, floppy and other removable disks, hard disk drives, optical disks (e.g., CD-ROM's, DVD's, etc.), among others, and transmission type media such as digital and analog communication links.

In addition, various program code described hereinafter may be identified based upon the application or software component within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which programs may be organized into routines, procedures, methods, modules, objects, and the like, as well as the various manners in which program functionality may be allocated among various software layers (e.g., operating systems, libraries, APIs, applications, applets, etc.), it should be appreciated that the invention is not limited to the specific organization and allocation of program functionality described herein.

### Software Description and Flows

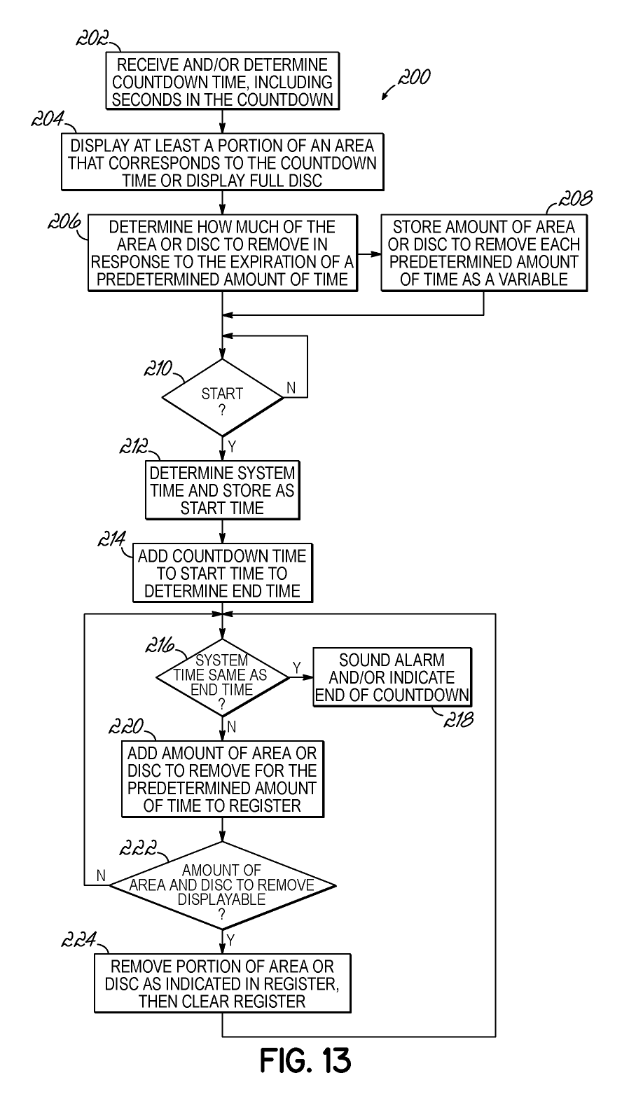

FIG. 13 is a flowchart 200 illustrating a sequence of operations to display a colored area and/or disc and remove portions thereof as time expires from a countdown. Specifically, a countdown time is initially received and determined, including the seconds that the countdown is to last (block 202). The countdown time is set by a user adjusting a number of hours, minutes, and/or seconds associated with the countdown time, by the user adjusting the duration of a countdown time, by the user adjusting the edge of a colored area, or by another manner consistent with embodiments of the invention. The countdown time is associated with hours, minutes, and/or seconds. In turn, this countdown time is converted to seconds. For example, if the countdown time is five minutes, that is converted to 300 seconds. However, if the countdown timer is one hour, twenty-two minutes, and thirteen seconds, that is converted to 4933 seconds. Then, at least a portion of an area corresponding to the countdown time, or a full disc that is associated with the countdown time, is displayed (block 204).

After displaying the area or disc, the sequence of operations determines the how much of the area or disc to remove in response to the expiration of a predetermined amount of time (e.g., the percentage of the area or disc to remove in response to the expiration of a predetermined amount of time, the predetermined amount of time generally being one second) (block 206). The sequence of operations stores that determined percentage as a variable (block 208) and determines whether the countdown has started (block 210). When the countdown has not started (“No” branch of decision block 210), it is again determined whether the countdown has started (block 210). When the countdown has started (“Yes” branch of decision block 210) the time of the apparatus executing the sequence of operations is determined (e.g., the “system” time) and stored as a start time (block 212) and the number of seconds for the countdown time is added to the start time to determine the end time (e.g., the time at which the countdown should end) (block 214).

In response to determining the end time, the sequence of operations determines whether the system time is the same as the end time (block 216). Specifically, the determination in block 214 may be made one or more times per second, triggered in response to the system time advancing one second, or triggered in response to the expiration of the predetermined amount of time. When the system time is the same as the end time (e.g., the countdown is over) (“Yes” branch of decision block 216) an indication that time has elapsed is made and/or an alarm is sounded (block 218). In particular, the indication that the time has elapsed may include completely removing any remaining area or disc, providing text indicating that the countdown has ended, or otherwise indicating that the countdown has ended.

When the system time is not the same as the end time (“No” branch of decision block 216), the sequence of operations adds the amount of area or disc to remove for the predetermined amount of time to a value in a register (block 220). The sequence of operations then determines whether the amount of the area or disc to remove stored in the register is displayable (block 222). For example, a countdown may be for six hours, five minutes, and thirty-two seconds, or 21,932 seconds. Thus, a disc associated with that countdown would be decreased by about 0.0000456% each second. However, the removal of that amount from the disc may not be displayable, depending upon the output device. Thus, the sequence of operations may determine, based upon the settings of the output device (e.g., its resolution and/or size, among other variables) as well as the amount of the area or disc to remove stored in the register (e.g., either for one predetermined unit of time or for multiple predetermined units of time that have been accumulating in the register), whether that the amount of the area or disc to remove stored in the register is displayable (block 222). When the amount of the area or disc to remove is displayable (“Yes” branch of decision block 222) the sequence of operations removes that amount from the area or disc then clears the register (block 224) and returns to block 216. However, when the amount of the area or disc to remove is not displayable (“No” branch of decision block 222), the sequence of operations returns to block 216.

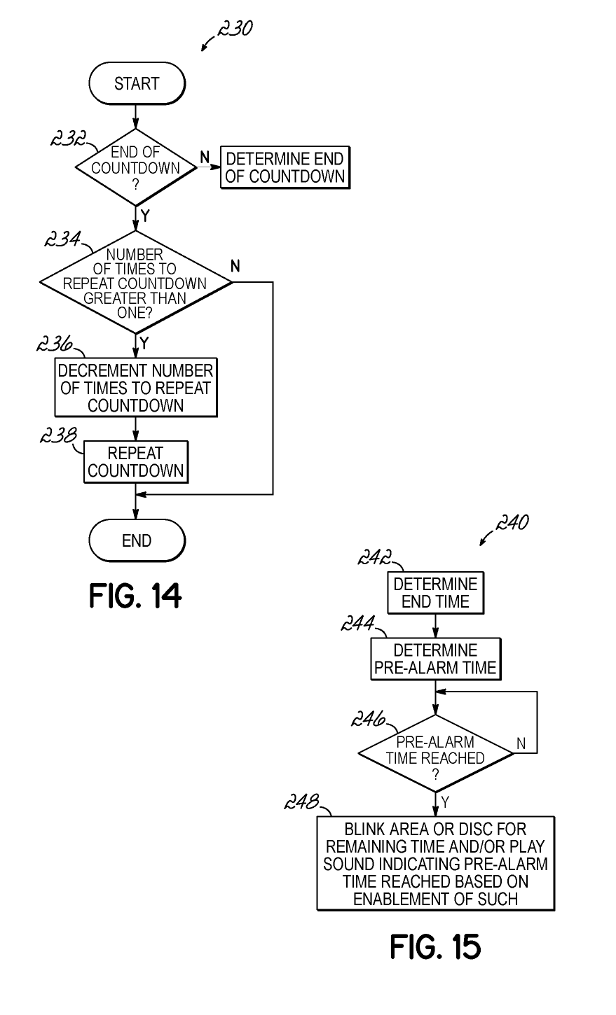

FIG. 14 is a flowchart 230 illustrating a sequence of operations to determine whether to repeat a countdown consistent with embodiments of the invention. Specifically, the sequence of operations may begin by determining that a countdown has ended (block 232). In response, it is determined whether the number of times to repeat the countdown is greater than one (block 234). When the number of times to repeat the countdown is not greater than one (“No” branch of decision block 234) the sequence of operations ends. However, when the number of times to repeat the countdown is greater than one (“Yes” branch of decision block 234) the number of times to repeat the countdown is decremented (block 236) and the countdown is repeated (block 238).

FIG. 15 is a flowchart 240 illustrating a sequence of operations to determine whether to sound a pre-alarm and/or selectively blink the area or disc associated with a countdown in response to that countdown reaching a pre-alarm time. Specifically, the sequence of operations determines the end time (such as described above in connection with FIG. 13) (block 242) and determines the pre-alarm time (block 244). In particular, the pre-alarm time may be determined by determining a system time that is ten seconds before the end time. The sequence of operations then determines whether the pre-alarm time has been reached (e.g., whether the system time is the same as the pre-alarm time) (block 246). When the pre-alarm time has not been reached (“No” branch of decision block 246) the sequence of operations returns to block 246. However, when the pre-alarm time has been reached (“Yes” branch of decision block 248) the area or disc is selectively blinked for the remaining time of the countdown when the user has enabled the blinking and a pre-alarm sound is played indicating that the pre-alarm time has been reached when the user has enabled pre-alarm sounds (block 248).

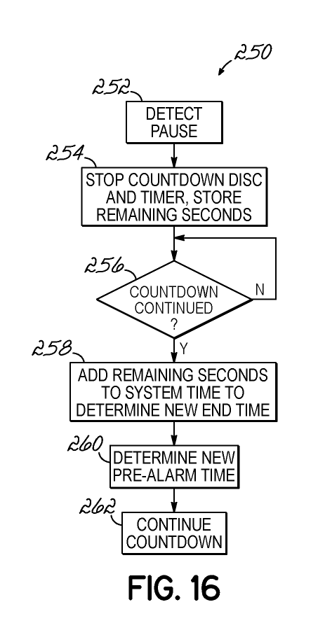

FIG. 16 is a flowchart 250 illustrating a sequence of operations to pause and resume a countdown. Initially, a pause is detected, such as from the user selecting a “Play” button when a countdown is currently underway (block 252). In response, the countdown is stopped and the remaining seconds left in the countdown are stored (block 254). The sequence of operations then detects whether the countdown is continued (block 256). When the countdown is not continued (“No” branch of decision block 256) the sequence of operations may return to block 256. Note, however, that the sequence of operations may not return to block 256 when the user navigates to a different screen, closes an application that includes the sequence of operations, restarts the countdown from the beginning, or changes the settings of the countdown (e.g., increases or decreases the time associated with the countdown). However, when the countdown is continued, such as when the user again presses the “Play” button (“Yes” branch of decision block 256), the sequence of operations adds the remaining seconds to the system time when the countdown is continued to determine the new end time (block 258) and in an optional step determines a new pre-alarm time by determining a time about ten seconds before the end time (block 260). The sequence of operations then continues the countdown (block 262).

While the present invention has been illustrated by a description of the various embodiments, and while these embodiments have been described in considerable detail, it is not the intention to restrict or in any way limit the scope of the appended claims to such detail. Additional advantages and modifications will readily appear to those skilled in the art. Thus, the invention in its broader aspects is therefore not limited to the specific details, representative apparatus and method, and illustrative examples shown and described. In particular, a person having ordinary skill in the art will appreciate that any of the blocks of the above flowcharts may be deleted, augmented, made to be simultaneous with another, combined, or be otherwise altered in accordance with the principles of the embodiments of the invention. Accordingly, departures may be made from such details without departing from the spirit or scope of applicant's general inventive concept.

Although I have described various embodiments of the invention, I do not intend to be limited except by the scope of the following claims.

I claim:

1. A method of managing time, comprising:
receiving, with a hardware processing element, a countdown time that is associated with hours, minutes, and seconds;
graphically displaying a circular colored disc representing the hours, minutes, and seconds; and
in response to at least a portion of the countdown time elapsing, removing at least a portion of the disc.

2. The method of claim 1, wherein the portion of the disc removed is proportional to the ratio of the portion of the elapsed countdown time to the countdown time.

3. The method of claim 1, further comprising:
in response to the countdown time fully elapsing, determining whether the countdown is to be repeated.

4. The method of claim 2, further comprising:
repeating the countdown in response to determining that the countdown is to be repeated.

5. The method of claim 1, further comprising:
displaying a timer that indicates the countdown time.

6. The method of claim 5, further comprising:
selectively changing the location of the displayed timer from a first location to a second location.

7. The method of claim 1, wherein the portion of the disc is removed in a clockwise manner.

8. The method of claim 1, wherein portions of the disc are removed continuously as the countdown time elapses.

9. The method of claim 1, further comprising:
displaying text associated with configuring the countdown time; and
in response to user input, selectively changing the language in which the text appears.

10. An apparatus, comprising:
a display;
at least one hardware processing element; and
a memory containing program code, the program code configured to, when executed by the at least one hardware processing element, receive a countdown time that is associated with hours, minutes, and seconds, graphically display a circular colored disc representing the hours, minutes, and seconds, and in response to at least a portion of the countdown time elapsing, remove at least a portion of the disc.

11. The apparatus of claim 10, wherein the portion of the disc removed is proportional to the ratio of the portion of the elapsed countdown time to the countdown time.

12. The apparatus of claim 10, wherein the program code is further configured to determine whether the countdown is to be repeated in response to the countdown time fully elapsing.

13. The apparatus of claim 10, wherein the program code is further configured to repeat the countdown in response to determining that the countdown is to be repeated.

14. The apparatus of claim 10, wherein the program code is further configured to display a timer that indicates the countdown time.

15. The apparatus of claim 14, wherein the program code is further configured to selectively change the location of the timer on the display from a first location to a second location of the display.

16. The apparatus of claim 10, wherein the portion of the disc is removed in a clockwise manner.

17. The apparatus of claim 10, wherein portions of the disc are removed continuously as the countdown time elapses.

18. The apparatus of claim 10, wherein the program code is further configured to display text associated with configuring the countdown time and selectively change the language in which the text appears in response to user input.

19. The apparatus of claim 10, wherein the apparatus is a computing system.

20. The apparatus of claim 10, wherein the apparatus is a telecommunications device.

21. The apparatus of claim 11, wherein the apparatus is a wrist-watch.

22. A program product, comprising:
program code for managing time, the program code configured to, when executed by at least one hardware processing element, receive a countdown time that is associated with hours, minutes, and seconds, graphically display a circular colored disc representing the hours, minutes, and seconds, and in response to at least a portion of the countdown time elapsing, remove at least a portion of the disc; and
a computer readable medium bearing the program code.

23. A method of managing time, comprising:
selecting a custom mode of an application, wherein the custom mode displays a fully circular colored disc;
inputting a predetermined time associated with hours, minutes, and seconds utilizing a time set area at the bottom of a window displayed in the custom mode, wherein the disc is associated with the hours, minutes, and seconds; and
starting the custom mode to count down the predetermined time, wherein the disc represents the total of the predetermined time and, as time elapses, the disc disappears.
